(19) United States
(12) Patent Application Publication
(10) Pub. No.: US 2018/0355262 A1
(43) Pub. Date: Dec. 13, 2018

(54) HYBRID REACTOR HEAVY PRODUCT UPGRADING METHOD WITH DISPERSED CATALYST UPTAKE

(71) Applicant: IFP Energies nouvelles, Rueil-Malmaison (FR)

(72) Inventors: Matthieu DREILLARD, Lyon (FR); Jerome MAJCHER, Lyon (FR); Joao MARQUES, Chasse sur Rhone (FR); Pascal CHATRON-MICHAUD, Lyon (FR)

(73) Assignee: IFP Energies nouvelles, Rueil-Malmaison (FR)

(21) Appl. No.: 16/064,799

(22) PCT Filed: Dec. 2, 2016
(86) PCT No.: PCT/EP2016/079647

§ 371 Date: Jun. 21, 2018

(30) Foreign Application Priority Data
Dec. 21, 2015 (FR) 1562948

(51) Int. Cl. C10G 45/04; B01J 23/28; B01J 23/882; B01J 23/883; B01J 35/02; B01J 35/10

(52) U.S. Cl. CPC C10G 45/04; C10G 2300/107; B01J 23/882; B01J 23/883; B01J 35/023; B01J 35/1014; B01J 35/1019; B01J 35/1023; B01J 35/1028; B01J 35/1066; B01J 35/1071; B01J 35/1076; C10G 2300/202; C10G 2300/205; B01J 23/28

(57) ABSTRACT

The invention concerns a process for the hydrotreatment of a heavy oil feed in at least one reactor containing a fixed bed catalyst, in which a solution containing a dispersed catalyst or a precursor of a dispersed catalyst is continuously introduced into said reactor, the particle size of said dispersed catalyst being in the range 1 nm to 100 μm.

More particularly, the invention concerns the in situ formation of a catalyst for a hydrotreatment process starting from a fixed bed catalyst which captures a dispersed catalyst on its solid support.

### FIELD OF THE INVENTION

The invention relates to the field of oil refining, and more particularly to the field of the catalytic hydrotreatment of oil cuts.

### PRIOR ART

In general, a hydrotreatment is carried out in the presence of one or more fixed bed or ebullated bed catalysts, or catalysts in a dispersion of fine particles routinely known as a slurry. Fixed bed catalysts are supported by a solid, while dispersed catalysts are in the form of fine particles distributed throughout the reaction medium.

Fixed bed catalysts are composed of an active phase deposited on a solid support which is generally constituted by alumina or silica-alumina. Conventionally, a liquid solution generally containing molybdenum and/or tungsten is impregnated ex-situ onto said solid support before using said catalyst.

The dispersed catalysts are generally in the form of a complex of the active phase, usually containing molybdenum and/or tungsten, with a liposoluble organic ligand.

The active phase of a catalyst is the essential phase, generally composed of metals, which can catalyse the reaction thanks to its molecular structure.

Hydrotreatment catalysts are always being studied with a view to improving their performance.

Thus, U.S. Pat. No. 7,578,928 and U.S. Pat. No. 7,517,446 propose associating a colloidal catalyst with a fixed bed catalyst in order to constitute a hybrid bed. This type of hybrid bed can be used to treat a wider range of feeds because, in contrast to colloidal catalysts, fixed bed catalysts can only treat a portion of the molecules of very large size, such as asphaltenes, which cannot enter the pores of the support of a fixed bed catalyst. A solution of a precursor of a colloidal catalyst is intimately mixed with the feed, which induces a particular affinity with the asphaltenes and which results in a particle size for the colloidal catalyst of less than 100 nm, and thus the colloidal catalyst can be localized around the asphaltenes. Thus, the asphaltenes are cracked by means of the colloidal catalyst and do not perturb the supported catalyst. The particles of colloidal catalyst are thus not captured by the fixed bed catalyst, and have to be separated from the outgoing effluent.

The article by Heon Jung et al. Energy & Fuels 2004, 18, 924-929 describes a method for extending the cycle time of a fixed bed hydrodesulphurization catalyst. Once the catalyst is no longer sufficiently active, precursors of metals which are soluble in the oil are injected all at once. Similar subsequent injections are carried out in order to reactivate the catalyst and thereby extend the service life of the catalyst.

Improving the performances and service life of catalysts has thus been studied in great depth, but there is still an interest in this type of work, because substantial savings can still be obtained by means of novel processes.

Thus, the Applicant has developed a novel type of hydrotreatment process employing a catalyst consisting of the combination of a fixed bed catalyst comprising only a little active phase with a dispersed catalyst which impregnates the solid support of said fixed bed catalyst in situ.

### OBJECTIVE OF THE INVENTION

Thus, the invention concerns a process for the hydrotreatment of a heavy oil feed in at least one reactor containing a fixed bed catalyst, in which a solution containing a dispersed catalyst or a precursor of a dispersed catalyst is continuously introduced into said reactor, the particle size of said dispersed catalyst being in the range 1 nm to 100 μm.

More particularly, the invention concerns the in situ formation of a catalyst for a hydrotreatment process starting from a fixed bed catalyst which captures a dispersed catalyst on its solid support.

One advantage of the present invention is a gain in stability with time and an extension of the service life of the catalyst.

Another advantage of the present invention is that the step for retreatment of the dispersed catalyst is dispensed with, because its active phase is captured by the fixed bed catalyst.

Another advantage of the present invention is the increase or maintenance of the performances of a hydrotreatment process by limiting the increase in the temperature which is necessary in order to compensate for deactivation of the catalyst.

### DETAILED DESCRIPTION OF THE INVENTION

The feed treated in the process in accordance with the invention is typically selected from hydrocarbon fractions produced in the refinery and heavy oil feeds.

The term “heavy oil feed” means oil containing hydrocarbons wherein at least 80% by weight have a boiling point of more than 300° C., atmospheric residues or vacuum residues, atmospheric residues or vacuum residues obtained from hydrotreatment, hydrocracking or hydroconversion, fresh or refined vacuum distillates, and deasphalted oils obtained from a deasphalting unit, alone or as a mixture.

Preferably, the feeds treated in the context of the present invention are constituted by hydrocarbon fractions obtained from a crude oil or from atmospheric distillation of a crude oil or from vacuum distillation of a crude oil, said feeds containing a fraction of at least 80% by weight of molecules having a boiling point of at least 300° C., preferably at least 350° C. and more preferably at least 375° C., and yet more preferably vacuum residues with a boiling point of at least 450° C., preferably at least 500° C. and more preferably at least 540° C.

Advantageously, said feed contains a residual fraction obtained from direct liquefaction of coal, a vacuum distillate obtained from the direct liquefaction of coal, or in fact a residual fraction obtained from the direct liquefaction of lignocellulosic biomass, alone or as a mixture.

These feeds may contain impurities such as metals, sulphur, nitrogen, Conradson carbon and compounds which are insoluble in heptane, termed C₇ asphaltenes. These types of feeds are in fact generally rich in impurities, with metals contents which are generally more than 20 ppm and even more than 100 ppm. The sulphur content is generally more than 0.5% by weight, and may even be more than 2% by weight.

C₇ asphaltenes are compounds which are known for their propensity to inhibit hydrotreatment catalysts by their ability to form heavy hydrocarbon residues, which are conventionally termed coke, and by their tendency to produce sediments which substantially limit the operability of the hydrotreatment units.

In accordance with the invention, said heavy oil feed is hydrotreated in at least one reactor. Advantageously, said reactor is a three phase reactor.

The hydrotreatment process is carried out under an absolute pressure in the range 2 MPa to 38 MPa, preferably in the range 5 MPa to 25 MPa and more preferably in the range 8 MPa to 20 MPa, at a temperature in the range 300° C. to 550° C., preferably in the range 350° C. to 500° C. and more preferably in the range 360° C. to 440° C.

The hourly space velocity (HSV) of the volume of feed with respect to the volume of catalyst is in the range 0.05 h⁻¹ to 10 h⁻¹, preferably in the range 0.1 h⁻¹ to 5 h⁻¹ and yet more preferably in the range 0.15 h⁻¹ to 2 h⁻¹.

The quantity of hydrogen mixed with the feed is preferably in the range 50 to 5000 normal cubic metres (Nm³) per cubic metre (m³) of liquid feed, preferably in the range 100 Nm³/m³ to 2000 Nm³/m³ and yet more preferably in the range 200 Nm³/m³ to 1000 Nm³/m³.

In accordance with the invention, said reactor contains a fixed bed catalyst. Said fixed bed catalyst contains one or more elements from groups 4 to 12 of the periodic table of the elements, which are deposited on a solid support. Advantageously, said solid support is selected from amorphous solids, and preferably selected from silica, alumina, silica-alumina, titanium dioxide and zeolites, alone or as a mixture. Preferably, the solid support is an alumina.

The term “total pore volume” means the volume measured by mercury porosimetry and determined by mercury intrusion porosimetry in accordance with the ASTM standard D4284-83 at a maximum pressure of 4000 bar, using a surface tension of 484 dynes/cm and a contact angle of 140°. The wetting angle is assumed to be 140°, in accordance with the recommedations in the work entitled “Techniques de l'ingénieur, traité analyse et caractérisation [Engineering techniques, analysis and characterization], P 1050-5, written by Jean Charpin and Bernard Rasneur.

Preferably, the total pore volume of said solid support is in the range 0.5 mL/g to 3.0 mL/g, preferably in the range 0.5 mL/g to 2.0 mL/g, and more preferably in the range 0.5 mL/g to 1.5 mL/g.

Said solid support for the fixed bed catalyst used in the process in accordance with the invention has a pore distribution comprising macropores and mesopores. The volume of the macropores and mesopores is measured by mercury intrusion porosimetry in accordance with the ASTM standard D4284-83 at a maximum pressure of 4000 bar, using a surface tension of 484 dynes/cm and a contact angle of 140°.

The term “macropores” means pores with an opening of more than 50 nm.

The macropore volume of said solid support for the fixed bed catalyst preferably represents in the range 0 to 80% of the total pore volume, preferably in the range 5% to 70% of the total pore volume and more preferably in the range 10% to 60% of the total pore volume.

The macropore volume of said solid support for the fixed bed catalyst is defined as being the cumulative volume of mercury introduced at a pressure in the range 0.2 MPa to 30 MPa, corresponding to the volume contained in pores with an apparent diameter of more than 50 nm.

Said macropore volume of said solid support for the fixed bed catalyst is advantageously in the range 0.0 mL/g to 2.4 mL/g, preferably in the range 0.1 mL/g to 2.0 mL/g and more preferably in the range 0.3 mL/g to 1.5 mL/g.

Furthermore, the median diameter of the macropores (Dₚ, in nm) of the support is defined as being a diameter such that all pores with a size which is below that diameter constitutes 50% of the total macropore volume, measured by mercury porosimetry.

Said median diameter for the macropores of said solid support of the fixed bed catalyst is advantageously in the range 100 nm to 5000 nm, and preferably in the range 150 nm to 3000 nm, preferably in the range 200 nm to 2000 nm and yet more preferably in the range 300 nm to 1000 nm.

The term “mesopores” means pores the opening of which is in the range 2 nm to 50 nm, limits included.

The mesopore volume of said solid support of the fixed bed catalyst preferably represents in the range 20% to 100% of the total pore volume, preferably in the range 30% to 95% of the total pore volume and more preferably in the range 40% to 90% of the total pore volume.

The mesopore volume of said solid support of the fixed bed catalyst is defined as being the cumulative volume of mercury introduced at a pressure in the range 30 MPa to 400 MPa corresponding to the volume contained in pores with an apparent diameter in the range 2 to 50 nm.

Said mesopore volume of said solid support of the fixed bed catalyst is advantageously in the range 0.1 mL/g to 3.0 mL/g, preferably in the range 0.3 mL/g to 2.0 mL/g, and more preferably in the range 0.5 mL/g to 1.5 mL/g.

The median diameter of the mesopores (Dₚ, in nm) of the support is defined as being a diameter such that all mesopores with a size which is below that diameter constitutes 50% of the total mesopore volume, measured by mercury porosimetry.

Said median diameter of the mesopores of said solid support of the fixed bed catalyst is advantageously in the range 10 nm to 40 nm, preferably in the range 15 nm to 30 nm and more preferably in the range 18 nm to 25 nm.

Said solid support for the fixed bed catalyst advantageously has a specific surface area of more than 75 m²/g, preferably more than 100 m²/g, and more preferably more than 125 m²/g.

The term “specific surface area” means the BET specific surface area determined by nitrogen adsorption in accordance with the ASTM standard D 3663-78 established in accordance with the BRUNAUER-EMMETT-TELLER method described in the periodical “The Journal of the American Chemical Society”, 60, 309, (1938).

Advantageously, said fixed bed catalyst contains at least one metal from group VIB. Preferably, said metal from group VIB is selected from molybdenum and tungsten. Highly preferably, said metal from group VIB is molybdenum.

Advantageously, said metal from group VIB is used in association with at least one metal from group VIII. Preferably, said metal from group VIII is selected from nickel and cobalt. Highly preferably, said metal from group VIII is nickel.

Preferably, said fixed bed catalyst comprises nickel and molybdenum and more preferably, said fixed bed catalyst comprises nickel, cobalt and molybdenum.

In the case in which said fixed bed catalyst comprises molybdenum, the molybdenum content, expressed as the weight of molybdenum trioxide (MoO₃), is advantageously in the range 0.5% by weight to 30% by weight, preferably in the range 1% by weight to 15% by weight.

In the case in which said fixed bed catalyst comprises nickel, the nickel content, expressed as the weight of nickel oxide (NiO), is advantageously less than 10% by weight, preferably less than 6% by weight.

Advantageously, said fixed bed catalyst further contains phosphorus and/or fluorine in an amount of 10% by weight or less, preferably 5% by weight or less.

Said fixed bed catalyst is advantageously in the form of extrudates or beads. The size of said fixed bed catalyst is in the range 0.1 mm to 10 mm, preferably in the range 0.5 mm to 7 mm, and more preferably in the range 0.5 mm to 5 mm.

Preferably, said fixed bed catalyst is prepared using conventional methods such as co-mixing or impregnation followed by one or more heat treatments.

Said fixed bed catalyst is advantageously used after it has undergone a step for activation by sulphurization or by reduction.

In accordance with the invention, a solution containing a dispersed catalyst or a precursor of a dispersed catalyst is continuously introduced into said reactor. Said dispersed catalyst may advantageously be formed in situ, inside the reactor, under the reaction conditions for the hydrotreatment step, starting from said precursor of a dispersed catalyst, or ex situ, outside the reactor. Preferably, the dispersed catalyst is formed in situ from said dispersed catalyst precursor.

In accordance with the invention, said dispersed catalyst has a size in the range 1 nm to 100 μm. Preferably, said dispersed catalyst has a size in the range 10 nm to 75 μm, and more preferably a size in the range 100 nm to 50 μm.

Advantageously, said solution containing said dispersed catalyst or said precursor of a dispersed catalyst is introduced continuously with the feed or with a conveying fluid, said dispersed catalyst not being deposited on a solid support.

In the case in which said solution is introduced with a conveying fluid, said fluid is selected from aromatic hydrocarbons and vacuum distillates, alone or as a mixture.

Said solution is introduced continuously via at least one reactor inlet, said inlet being located at different levels in the reactor, at the bottom of the reactor, at the top of the reactor or at any point between the bottom and the top of the reactor.

Before being dissolved, said dispersed catalyst or said precursor of a dispersed catalyst is either in the solid form or in the liquid form.

In the case in which said dispersed catalyst or said precursor of a dispersed catalyst is in the solid form, it is advantageously selected from pyrite and molybdenum sulphide.

In the case in which said dispersed catalyst or said precursor of a dispersed catalyst is in the liquid form, it is advantageously selected from precursors of soluble metals in organic or aqueous media, and preferably selected from molybdenum naphthenate, nickel naphthenate, vanadium naphthenate, phosphomolybdic acids, ammonium molybdates, molybdenum octoates, in particular molybdenum 2-ethylhexanoate, nickel octoate, vanadium octoate and pentacarbonyl iron.

Said dispersed catalyst is activated in situ or ex situ, either by reduction in hydrogen or by sulphurization.

The quantity of dispersed catalyst in the reactor or reactors is in the range 1 ppm by weight to 10000 ppm by weight with respect to the feed, and preferably in the range 10 ppm by weight to 300 ppm by weight.

The dispersed catalyst is deposited on the fixed bed catalyst, which means that an active phase can be maintained on the support even if said fixed bed catalyst is already partially coked. Furthermore, depositing the dispersed catalyst on the fixed bed catalyst means that a step for separation from the final effluent can be dispensed with.

### BRIEF DESCRIPTION OF THE FIGURES

FIG. 1 is a graph representing the temperature rise profiles necessary in order to compensate for deactivation of the catalyst in accordance with the prior art and in accordance with the invention.

### EXAMPLES

### Example No 1

### Example 1: Fixed Bed Hydrotreatment (not in Accordance with the Invention)

Example 1 was not in accordance with the invention, in that neither was the catalyst dispersed, nor was the dispersed catalyst precursor injected.

An atmospheric distillation residue with a D 15/4 density of 0.99 containing 4% by weight of sulphur, and 90 ppm by weight of metals was hydrotreated in the presence of hydrogen under a pressure of 15 MPa with a HSV of 0.8 h⁻¹. The temperature of the reactor was increased with time in order to compensate for the reduction in activity of the catalyst.

The active phase of the catalyst employed comprised 4% of molybdenum. Said active phase was deposited onto an alumina type support with a pore volume of 1 mL/g. The macropore volume was 40% of the total pore volume, with a median macropore diameter of 1000 nm.

The effluent produced by the hydrotreatment had a D 15/4 density of 0.95 and a metals content of 30 ppm by weight.

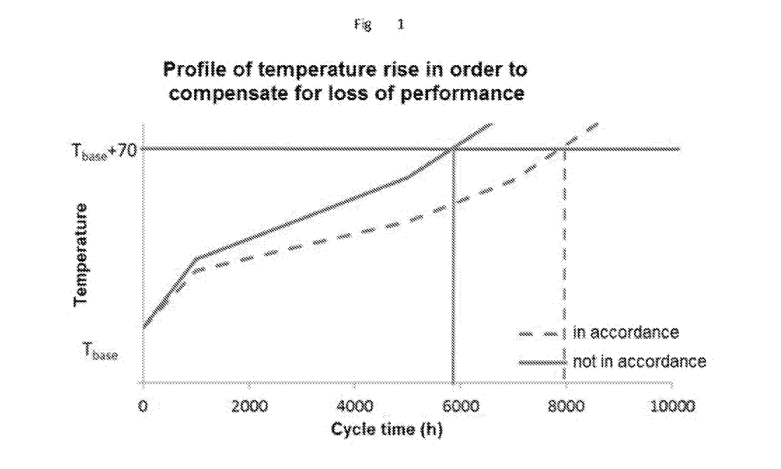

The solid line in FIG. 1 shows the profile of the temperature rise for the reaction medium in order to compensate for its deactivation. The initial temperature employed was Tbase. After having increased the temperature by 70° C. with respect to Tbase, the temperature was too high for the hydrotreatment to be able to produce quality products. Tbase+70° C. was reached after 5800 h of reaction.

### Example 2: Fixed Bed Hydrotreatment with Continuous Introduction of a Dispersed Catalyst (in Accordance with the Invention)

The process carried out in Example 2 was similar to the process carried out in Example 1, but with the additional continuous injection of a solution of molybdenum in gas oil concomitantly with the atmospheric distillation residue.

The molybdenum precursor, molybdenum 2-ethylhexanoate, was mixed with vacuum distillate in order to obtain a quantity of dispersed catalyst in the reactor of 10 ppm by weight with respect to the feed.

The effluent produced by the hydrotreatment had a D 15/4 density of 0.95 and a metals content of 30 ppm by weight.

The dashed line in FIG. 1 shows the profile of the temperature rise for the reaction medium in order to compensate for its deactivation. The temperature Tbase+70° C., beyond which the hydrotreatment could no longer be carried out in order to obtain quality products, was reached after 7900 h of reaction.

FIG. 1 shows that the temperature rise was slower in the process in accordance with the invention. Thus, the process in accordance with the invention can be used to significantly increase the cycle time by 2100 h, i.e. approximately 36%.

1. A process for the hydrotreatment of a heavy oil feed in at least one reactor containing a fixed bed catalyst composed of an active phase deposited on a solid support, in which a solution containing a dispersed catalyst or a precursor of a dispersed catalyst is continuously introduced into said reactor, the particle size of said dispersed catalyst being in the range 1 nm to 100 μm, said fixed bed catalyst capturing said dispersed catalyst on its solid support.

2. The process as claimed in claim 1, in which the particle size of said dispersed catalyst is in the range 10 nm to 75 μm.

3. The process as claimed in claim 1, in which the feed is selected from feeds constituted by hydrocarbon fractions obtained from a crude oil or from atmospheric distillation of a crude oil or from vacuum distillation of a crude oil, said feeds containing a fraction of at least 80% by weight of molecules having a boiling point of at least 300° C.

4. The process as claimed in claim 1, in which the hydrotreatment process is carried out at an absolute pressure in the range 2 MPa to 38 MPa and at a temperature in the range 300° C. to 550° C., and with an hourly space velocity (HSV) of the volume of feed with respect to the volume of catalyst in the range 0.05 h⁻¹ to 10 h⁻¹.

5. The process as claimed in claim 1, in which said fixed bed catalyst contains one or more elements from groups 4 to 12 of the periodic table of the elements which are deposited on said solid support.

6. The process as claimed in claim 5, in which said solid support for the fixed bed catalyst is selected from amorphous solids selected from silica, alumina, silica-alumina, titanium dioxide and zeolites, alone or as a mixture.

7. The process as claimed in claim 5, in which the macropore volume of said solid support of the fixed bed catalyst represents in the range 0 to 80% of the total pore volume, the median diameter of the macropores of said solid support of the fixed bed catalyst is in the range 100 nm to 5000 nm, and the specific surface area of said solid support of the fixed bed catalyst is more than 75 m²/g.

8. The process as claimed in claim 5, in which said fixed bed catalyst contains at least one metal from group VIB.

9. The process as claimed in claim 8, in which said metal from group VIB is selected from molybdenum and tungsten.

10. The process as claimed in claim 8, in which said metal from group VIB is used in association with at least one metal from group VIII.

11. The process as claimed in claim 10, in which said metal from group VIII is selected from nickel and cobalt.

12. The process as claimed in claim 1, in which said solution containing said dispersed catalyst or said precursor of a dispersed catalyst is introduced continuously with the feed or with a conveying fluid.

13. The process as claimed in claim 12, in which said conveying fluid is selected from aromatic hydrocarbons and vacuum distillates, alone or as a mixture.

14. The process as claimed in claim 1, in which said dispersed catalyst or said precursor of a dispersed catalyst is selected from pyrite and molybdenum sulphide or selected from molybdenum naphthenate, nickel naphthenate, vanadium naphthenate, phosphomolybdic acids, ammonium molybdates, molybdenum octoates, nickel octoate, vanadium octoate and pentacarbonyl iron.

15. The process as claimed in claim 1, in which the quantity of dispersed catalyst in the reactor or reactors is in the range 1 ppm by weight to 10000 ppm by weight with respect to the feed.
